(19) United States
(12) Patent Application Publication
(10) Pub. No.: US 2018/0166901 A1
(43) Pub. Date: Jun. 14, 2018

(54) ENERGY-HARVESTING SYSTEM AND CONTROL METHOD THEREOF

(71) Applicant: Industrial Technology Research Institute, Hsinchu (TW)

(72) Inventor: Ming-Hung YU, Zhudong Township (TW)

(73) Assignee: Industrial Technology Research Institute, Hsinchu (TW)

(21) Appl. No.: 15/392,326

(22) Filed: Dec. 28, 2016

(30) Foreign Application Priority Data
Dec. 14, 2016 (TW) 105141370

(51) Int. Cl. H02J 7/00

(52) U.S. Cl. CPC H02J 7/0068; H02J 7/0052

(57) ABSTRACT

An energy-harvesting system and a control method for the energy-harvesting system are provided. A control circuit controls a switching circuit and makes an energy-storage circuit receive and store a first output current from an energy-harvesting circuit. The control circuit determines whether a first current stored in the energy-storage circuit is less than a predetermined current. If yes, the control circuit controls the switching circuit to make the energy-storage circuit receive and store the first output current, otherwise the control circuit controls the switching circuit to make a load device receive a second output current from the energy-storage circuit.

### CROSS REFERENCE TO RELATED APPLICATION

The present application is based on, and claims priority from, Taiwan Application Serial Number 105141370, filed on Dec. 14, 2016, the disclosure of which is hereby incorporated by reference herein in its entirety.

### TECHNICAL FIELD

The technical field relates to an energy-harvesting system and a control method thereof.

### BACKGROUND

Generally, an energy-harvesting system may collect the energy in an environment to generate electrical energy. The energy-harvesting system provides electrical energy, which may be converted and adjusted further, to power a load device. The environmental energy collected may be light energy, thermal energy, vibration energy, or the like. The voltage and current generated by the energy-harvesting system may change according to variations in the environmental energy collected, which may affect the output power of the energy-harvesting system.

### SUMMARY

A detailed description is given in the following embodiments with reference to the accompanying drawings.

According to some embodiments of the present disclosure, an energy-harvesting system is provided. The energy-harvesting system comprises an energy-harvesting circuit, an energy-storage circuit, a detection circuit, a switching circuit, and a control circuit. The detection circuit is coupled to the energy-storage circuit to detect a first current stored by the energy-storage circuit. The switching circuit is coupled to the energy-harvesting circuit, the energy-storage circuit, and a load device. The control circuit is coupled to the detection circuit and the switching circuit. If the control circuit determines that the first current is less than a predetermined current, the control circuit controls the switching circuit to make the energy-storage circuit receive and store a first output current provided by the energy-harvesting circuit. Otherwise the control circuit determines that the first current is greater than or equal to the predetermined current, the control circuit controls the switching circuit to make the load device receive a second output current provided by the energy-storage circuit.

According to some embodiments of the present disclosure, a control method of an energy-harvesting system is provided. The control method comprises controlling a switching circuit using a control circuit; If the control circuit determines that a first current stored by an energy-storage circuit is less than a predetermined current, the control circuit controls the switching circuit to make the energy-storage circuit receive and store a first output current provided by the energy-harvesting circuit; and If the control circuit determines that the first current is greater than or equal to the predetermined current, the control circuit controls the switching circuit to make a load device receive a second output current provided by the energy-storage circuit.

### BRIEF DESCRIPTION OF DRAWINGS

The present disclosure can be more fully understood by reading the subsequent detailed description and examples with references made to the accompanying drawings, wherein:

FIG. 1 is a schematic view of an energy-harvesting system according to an exemplary embodiment.

FIG. 2A is a schematic view of an energy-harvesting system according to an exemplary embodiment.

FIG. 2B illustrates the operation of an energy-harvesting system according to an exemplary embodiment.

FIG. 2C is a schematic view of an energy-harvesting system according to an exemplary embodiment.

FIG. 3A is a schematic view of an energy-harvesting system according to an exemplary embodiment.

FIG. 3B illustrates the operation of an energy-harvesting system according to an exemplary embodiment.

FIG. 4A is a schematic view of an energy-harvesting system according to an exemplary embodiment.

FIG. 4B illustrates the operation of an energy-harvesting system according to an exemplary embodiment.

FIG. 5A is a schematic view of an energy-harvesting system according to an exemplary embodiment.

FIG. 5B illustrates the operation of an energy-harvesting system according to an exemplary embodiment.

FIG. 6A is a flow diagram of the control method of an energy-harvesting system according to an exemplary embodiment.

FIG. 6B is a flow diagram of the control method of an energy-harvesting system according to an exemplary embodiment.

FIG. 7A-7B show a flow diagram of the control method of an energy-harvesting system according to an exemplary embodiment.

FIG. 8A-8B show a flow diagram of the control method of an energy-harvesting system according to an exemplary embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

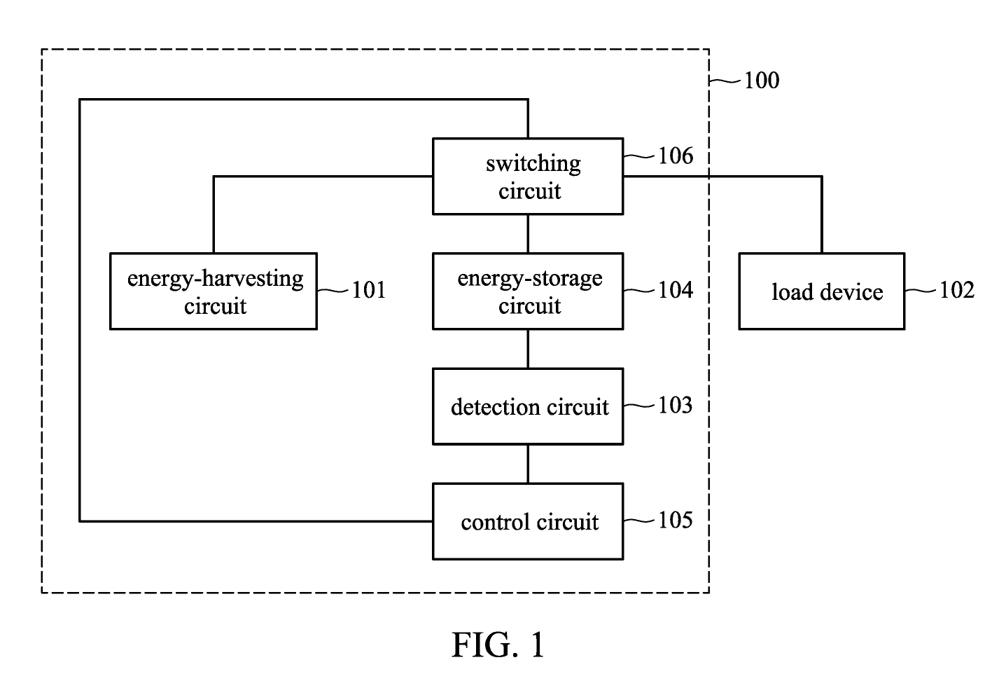

FIG. 1 is a schematic view of an energy-harvesting system 100 according to an exemplary embodiment. The energy-harvesting system 100 includes an energy-harvesting circuit 101, a detection circuit 103, an energy-storage circuit 104, a control circuit 105, and a switching circuit 106, wherein the switching circuit 106 comprises a plurality of switches.

The energy-harvesting circuit 101 receives energy from the environment (such as light energy, thermal energy, or vibration energy) and converts the received energy into voltage or current. The control circuit 105 is coupled to the detection circuit 103 and the switching circuit 106. The control circuit 105 may control the switching circuit 106 to establish or disconnect the electricity-transmission path between the energy-harvesting circuit 101 and the energy-storage circuit 104, and may control the switching circuit 106 to establish or disconnect the electricity-transmission path between the energy-storage circuit 104 and a load device 102.

When the energy-harvesting circuit 101 is already turned on and the control circuit 105 establishes the electricity-transmission path between the energy-harvesting circuit 101 and the energy-storage circuit 104 through the switching circuit 106, the energy-storage circuit 104 can receive and store the current generated by the energy-harvesting circuit 101. The detection circuit 103 may detect the current stored by the energy-storage circuit 104 and transmit the detection result to the control circuit 105. When the control circuit 105 determines that the current stored by the energy-storage circuit 104 is less than a predetermined current, the control circuit 105 controls the switching circuit 106 to make the energy-storage circuit 104 continue to receive and store the current generated by the energy-harvesting circuit 101. When the control circuit 105 determines that the current stored by the energy-storage circuit 104 is greater than or equal to the predetermined current, the control circuit 105 controls the switching circuit 106 to establish the electricity-transmission path between the energy-storage circuit 104 and the load device 102, which allows the energy-storage circuit 104 to provide current to the load device 102. In some embodiments, the detection circuit 103 may detect the voltage of the load device 102 (such as the voltage which is generated based on the current received from the energy-storage circuit 104) and transmit the voltage-detection result to the control circuit 105. According to the voltage-detection result, the control circuit 105 may control the switching circuit 106 to control or adjust the current transmitted from the energy-storage circuit 104 to the load device 102.

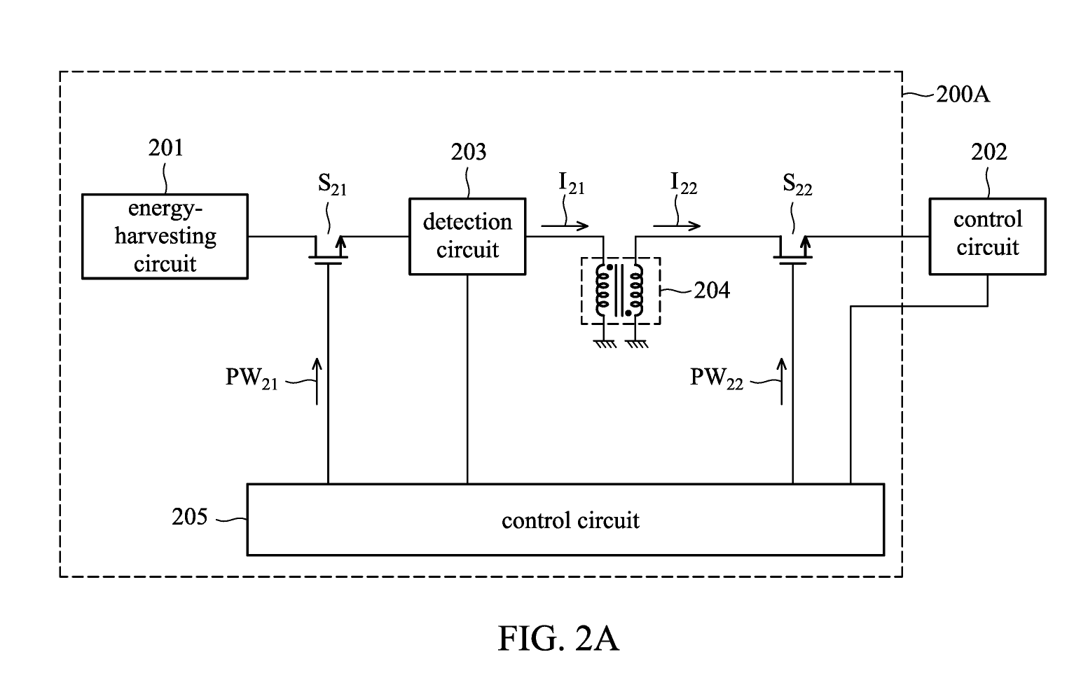

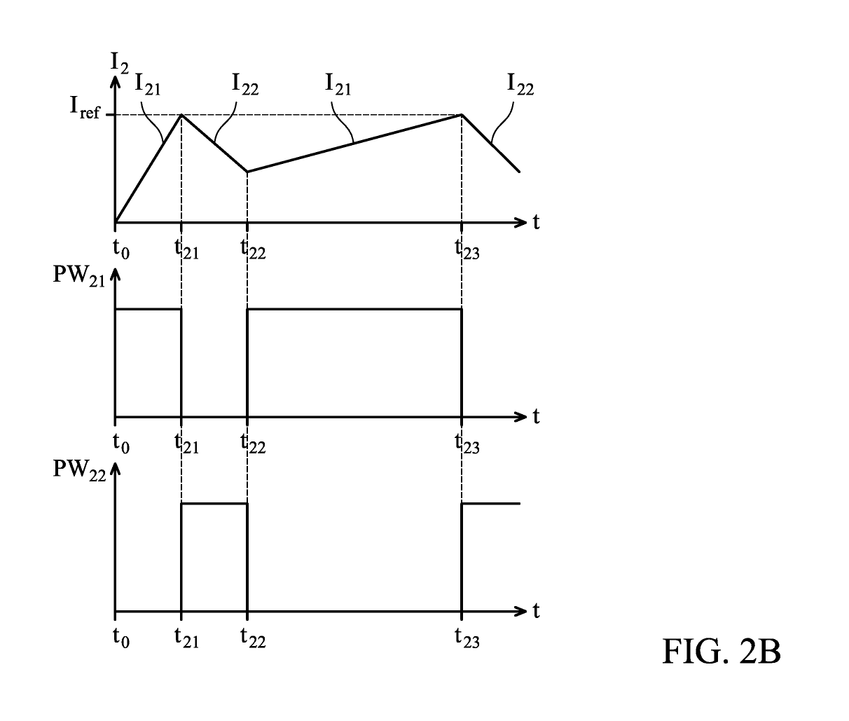

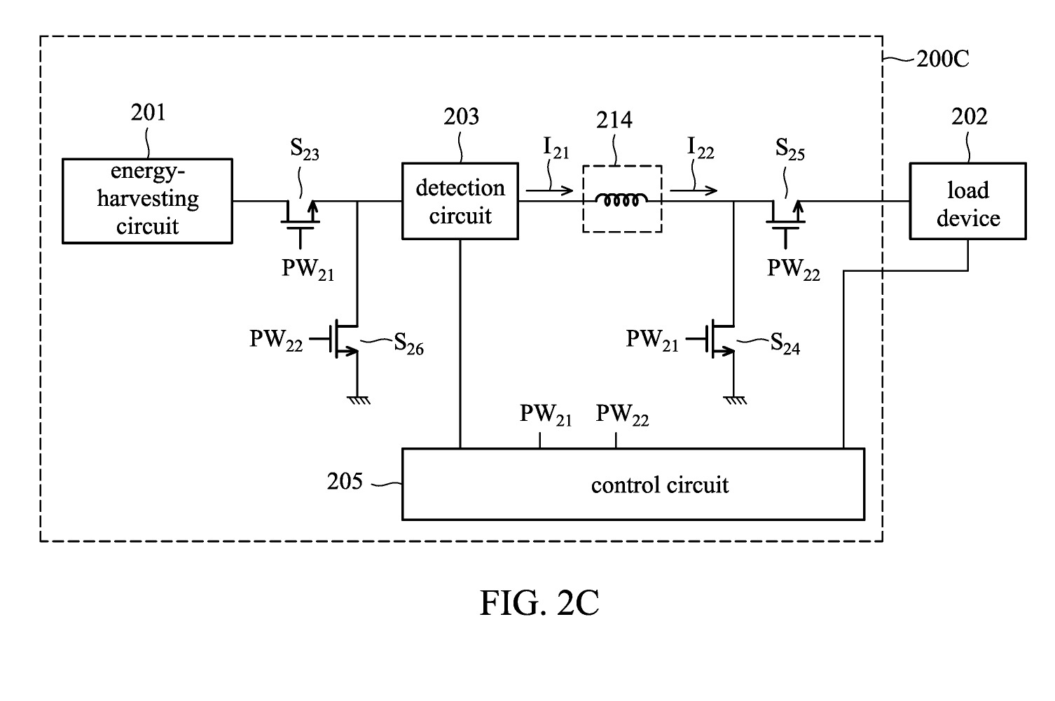

Specifically, an energy-harvesting system of an embodiment of the present disclosure is shown as the energy-harvesting system 200A in FIG. 2A. The energy-harvesting system 200A includes an energy-harvesting circuit 201, a detection circuit 203, an energy-storage circuit 204, a control circuit 205, and a switching circuit. In this embodiment, the switching circuit is formed by multiple switches (i.e. transistors S₂₁ and S₂₂), and the transistors S₂₁ and S₂₂ receive control signals PW₂₁ and PW₂₂ transmitted from the control circuit 205, respectively. An exemplary operation of the energy-harvesting system 200A may be as illustrated in FIG. 2B.

As shown in FIG. 2B, at time t₀, the energy-harvesting circuit 201 is already turned on and the control circuit 205 provides the control signal PW₂₁ with high voltage and the control signal PW₂₂ with low voltage, which establishes the current-transmission path between the energy-harvesting circuit 201 and the energy-storage circuit 204. In such cases, the energy-storage circuit 204 may receive and store the current I₂₁ provided by the energy-harvesting circuit 201 to make the current I₂ stored by the energy-storage circuit 204 gradually increase. At time t₂₁, the control circuit 205 determines that the current I₂ is greater than or equal to the predetermined current I_{ref} through the detection circuit 203. Accordingly, the control circuit 205 provides the control signal PW₂₁ with low voltage and the control signal PW₂₂ with high voltage, which disconnects the current-transmission path between the energy-harvesting circuit 201 and the energy-storage circuit 204 and establishes the current-transmission path between the energy-storage circuit 204 and the load device 202. In such cases, the energy-storage circuit 204 may provide the current I₂₂ to the load device 202 and make the current I₂ stored by the energy-storage circuit 204 gradually decrease. In some embodiments, the energy-storage circuit 204 may be a transformer, and the first winding and the second winding of the transformer may have the same number of turns or different numbers of turns.

At time t₂₂, the control circuit 205 detects the voltage or current of the load device 202 to determines that the load device 202 already receives sufficient electricity. Accordingly, the control circuit 205 provides the control signal PW₂₁ with high voltage and the control signal PW₂₂ with low voltage, which makes the energy-storage circuit 204 receive and store the current I₂₁ provided by the energy-harvesting circuit 201 and makes the current I₂ stored by the energy-storage circuit 204 gradually increase. At time t₂₃, the control circuit 205 determines that the current I₂ is greater than or equal to the predetermined current I_{ref} through the detection circuit 203. Accordingly, the control circuit 205 provides the control signal PW₂₁ with low voltage and the control signal PW₂₂ with high voltage, which disconnects the current-transmission path between the energy-harvesting circuit 201 and the energy-storage circuit 204 and makes the energy-storage circuit 204 provide the current I₂₂ to the load device 202.

As depicted in FIG. 2B, the environment energy received by the energy-harvesting circuit 201 may vary with time, and the current I₂₁ provided by the energy-harvesting circuit 201 may also change according to the environment energy. In such cases, the time required for the current stored by the energy-storage circuit 204 to be greater than or equal to the predetermined current I_{ref} may change according to the variation of the environment energy. Therefore, regarding the environment energy in this embodiment, the environment energy in the time period from time t₀ to time t₂₁ is greater than the environment energy in the time period from time t₂₂ to time t₂₃.

According to the mentioned embodiments, when the environment energy is weak, the energy-harvesting system 200A can still effectively store the current I₂₁ provided by the energy-harvesting circuit 201, and provide the current (such as the current I₂₂) to the load device if the current I₂ stored by the energy-storage circuit 204 is greater than or equal to the predetermined I_{ref}. Therefore, the energy-harvesting system 200A can effectively convert the environment energy into electricity and provide the electricity to the load device 202 regardless of how the environment energy changes.

As mentioned above, the energy-harvesting system 200A may convert the environment energy into the current provided to the load device 202. The conversion efficiency between the environment energy and the current provided to the load device 202 can be controlled by the setting of the predetermined current I_{ref}. In this embodiment, considering the energy loss of the energy-harvesting system 200A and the load device 202, the predetermined current I_{ref} is designed to provide the maximum energy/current conversion efficiency between the energy-harvesting system 200A and the load device 202. In some embodiments, the predetermined current I_{ref} may be designed in accordance with the needs of the circuit designer.

As mentioned above, the energy-harvesting system 200A in this embodiment provides the current stored by the energy-storage circuit 204 to the load device 202 when the current stored by the energy-storage circuit 204 is greater than or equal to the predetermined I_{ref}. Therefore, the energy-harvesting system 200A can ensure that each time the current is supplied to the load device 202, there is the maximum energy/current conversion efficiency between the energy-harvesting system 200A and the load device 202. Furthermore, since the energy-harvesting system 200A provides the current stored by the energy-storage circuit 204 to the load device 202 when the current stored by the energy-storage circuit 204 is greater than or equal to the predetermined I_{ref}, the switching circuit (i.e. the switching circuit formed by the transistor S₂₁ and S₂₂) of the energy-harvesting system 200A does not need to be switched based on a fixed frequency. In such cases, the number of switching operations of the switching circuit of the energy harvest system 200A can be minimized, so that the switching losses caused by the switching circuit of the energy harvesting system 200A (e.g., the losses caused by the on/off operations of the transistors S₂₁, S₂₂) can also be minimized.

In some embodiments, the energy-harvesting system 200A performs the maximum power point tracking (MPPT) on the energy-harvesting circuit 201, and the operation mode of the energy-harvesting system 200A is determined according to the current, which is provided by the energy-harvesting circuit 201, corresponding to the maximum power point. For example, when the current corresponding to the maximum power point is greater than a current threshold, the control circuit 205 provides control signal PW₂₁ and control signal PW₂₂ which are complementary to each other and have a fixed main frequency. For another example, when the current corresponding to the maximum power point is less than or equal to the current threshold, the operation of the energy-harvesting system 200A is as shown in FIG. 2B. The present disclosure is not limited by the operation described above.

In some embodiments, the switching circuit may use the switch components other than the transistors S₂₁ and S₂₂. In some embodiments, the energy-harvesting system 200A may include at least one voltage-detection circuit which is utilized to detect the voltages of the energy-harvesting circuit 201 and the load device 202. In some embodiments, the energy-harvesting system 200A may include at least one current-detection circuit.

In some embodiments, the energy-storage circuit 204 may be an inductor, as shown in FIG. 2C. The differences between the energy-harvesting system 200C in FIG. 2C and the energy-harvesting system 200A in FIG. 2A are the energy-storage circuit 214 and the switching circuit including multiple switches (i.e. transistors S₂₃-S₂₆) of the energy-harvesting system 200C. The transistors S₂₃ and S₂₄ receive the control signal PW₂₁ provided by the control circuit 205, and the transistors S₂₅ and S₂₆ receive the control signal PW₂₂ provided by the control circuit 205. The operation of the energy harvesting system 200C may correspond to the content in FIG. 2B, and will not be repeated here.

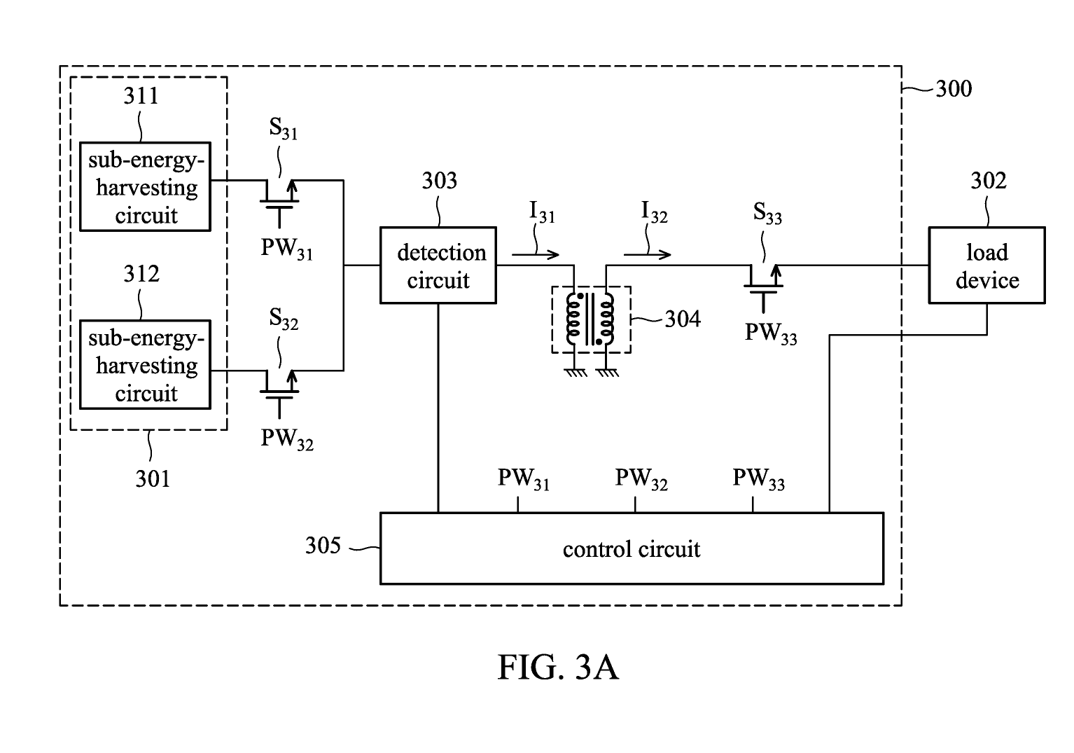

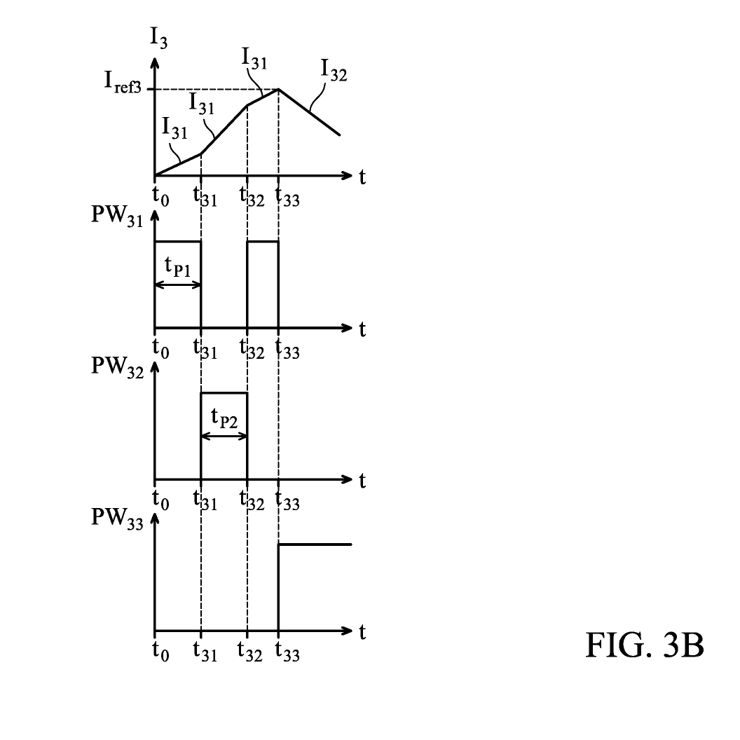

FIG. 3A is a schematic view of an energy-harvesting system 300 according to an exemplary embodiment. The energy-harvesting system 300 includes an energy-harvesting circuit 301, a detection circuit 303, an energy-storage circuit 304, a control circuit 305, and a switching circuit. In this embodiment, the energy-harvesting circuit 301 includes sub-energy-harvesting circuit 311 and sub-energy-harvesting circuit 312, and the switching circuit is formed by the transistors S₃₁, S₃₂, and S₃₃. In this embodiment, the transistors S₃₁, S₃₂, and S₃₃ receive control signals PW₃₁, PW₃₂, and PW₃₃ provided by the control circuit 305, respectively. An exemplary operation of the energy-harvesting system 300 is illustrated in FIG. 3B.

As shown in FIG. 3B, at time t₀, the sub-energy-harvesting circuit 311 is already turned on and the control circuit 305 provides the control signal PW₃₁ with high voltage and the control signals PW₃₂ and PW₃₃ with low voltage, which establishes the current-transmission path between the sub-energy-harvesting circuit 311 and the energy-storage circuit 304. In such cases, the energy-storage circuit 304 may receive and store the current I₃₁ provided by the energy-harvesting circuit 301 (i.e. sub-energy-harvesting circuit 311) to make the current I₃ stored by the energy-storage circuit 304 gradually increase. The control signal PW₃₁ performs high voltage over the predetermined period of time tp₁. At time t₃₁, the sub-energy-harvesting circuit 312 is already turned on and the control circuit 305 provides the control signal PW₃₂ with high voltage and the control signals PW₃₁ and PW₃₃ with low voltage, which establishes the current-transmission path between the sub-energy-harvesting circuit 312 and the energy-storage circuit 304. In such cases, the energy-storage circuit 304 may receive and store the current I₃₁ provided by the energy-harvesting circuit 301 (i.e. sub-energy-harvesting circuit 312) to make the current I₃ stored by the energy-storage circuit 304 continuously increase. The control signal PW₃₂ performs high voltage over the predetermined period of time tp₂. At time t₃₂, the control circuit 305 provides the control signal PW₃₁ with high voltage and the control signals PW₃₂ and PW₃₃ with low voltage, which establishes the current-transmission path between the sub-energy-harvesting circuit 311 and the energy-storage circuit 304 again and makes the energy-storage circuit 304 receive and store the current I₃₁ provided by the energy-harvesting circuit 301 (i.e. sub-energy-harvesting circuit 311). At time t₃₃, the control circuit 305 determines that the current I₃ is greater than or equal to the predetermined current I_{ref3} through the detection circuit 303. Accordingly, the control circuit 305 provides the control signal PW₃₃ with high voltage and the control signals PW₃₁ and PW₃₂ with low voltage, which disconnects the current-transmission paths between the sub-energy-harvesting circuits 311-312 and the energy-storage circuit 304 and establishes the current-transmission path between the energy-storage circuit 304 and the load device 302. In such cases, the energy-storage circuit 304 may provide the current I₃₂ to the load device 302 and makes the current I₃ stored by the energy-storage circuit 304 gradually decrease.

As shown in FIG. 3B, when the current I₃ stored by the energy-storage circuit 304 is less than the predetermined current I_{ref3}, the control circuit 305 may control the switching circuit to make the sub-energy-harvesting circuit 311 and sub-energy-harvesting circuit 312 alternatively provide the current (i.e. the current I₃₁ provide by the energy-harvesting circuit 301) to the energy-storage circuit 304. The control circuit 305 may also control the switching circuit to provide the current stored by the energy-storage circuit 304 to the load device 302 when the current I₃ is greater than or equal to the predetermined I_{ref3}. In some embodiments, the energy-harvesting circuit 301 may include more than two sub-energy-harvesting circuits (i.e. energy-harvesting circuit 301 may include a plurality of sub-energy-harvesting circuits). The control circuit 305 may control the switching circuit to make the sub-energy-harvesting circuits alternatively provide the current to the energy-storage circuit 304. The control circuit 305 may arbitrarily control the sequence and timing of providing the current of each sub-energy-harvesting circuit to the energy-storage circuit 304. The control circuit 305 may also control the switching circuit to provide the current stored by the energy-storage circuit 304 to the load device 302 when the current I₃ is greater than or equal to the predetermined I_{ref3}. In some embodiments, the energy-harvesting system 300 performs the MPPT on the sub-energy-harvesting circuits of the energy-harvesting circuit 301 (e.g. sub-energy-harvesting circuits 311 and 312). The predetermined period of time for operating each sub-energy-harvesting circuit (e.g. the predetermined period of time tp₁ and the predetermined period of time tp₂) is respectively determined according to the current, which is provided by each sub-energy-harvesting circuit, corresponding to the maximum power point of each sub-energy-harvesting circuit. For example, if the current, which is provided by a sub-energy-harvesting circuit, corresponding to the maximum power point of the sub-energy-harvesting circuit increases, then the predetermined period of time for operating the sub-energy-harvesting circuit also increases.

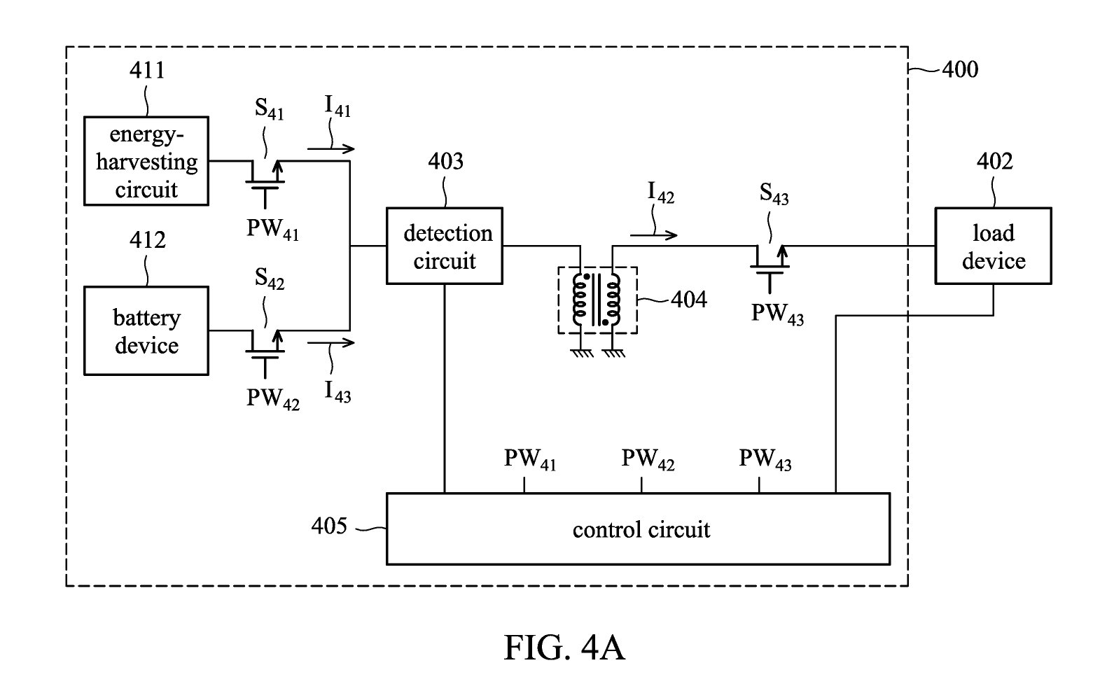

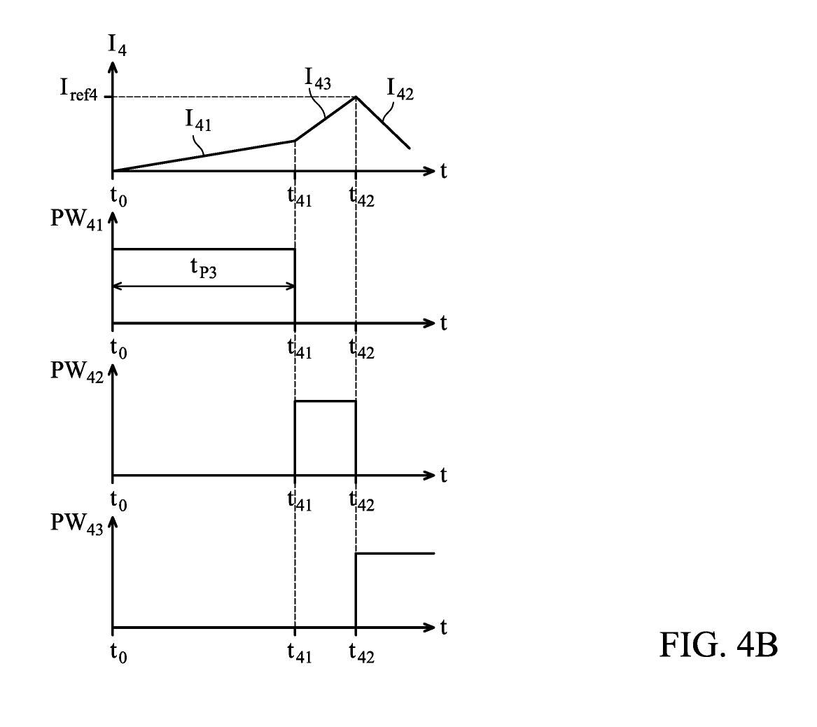

FIG. 4A is a schematic view of an energy-harvesting system 400 according to an exemplary embodiment. The energy-harvesting system 400 includes an energy-harvesting circuit 411, a battery device 412, a detection circuit 403, an energy-storage circuit 404, a control circuit 405, and a switching circuit. In this embodiment, the switching circuit is formed by the transistors S₄₁, S₄₂, and S₄₃, and the transistors S₄₁, S₄₂, and S₄₃ receive control signals PW₄₁, PW₄₂, and PW₄₃ provided by the control circuit 405, respectively. An exemplary operation of the energy-harvesting system 400 is illustrated in FIG. 4B.

As shown in FIG. 4B, at time t₀, the energy-harvesting circuit 411 is already turned on and the control circuit 405 provides the control signal PW₄₁ with high voltage and the control signals PW₄₂ and PW₄₃ with low voltage, which establishes the current-transmission path between the energy-harvesting circuit 411 and the energy-storage circuit 404. In such cases, the energy-storage circuit 404 may receive and store the current I₄₁ provided by the energy-harvesting circuit 411 to make the current I₄ stored by the energy-storage circuit 404 gradually increase. At time t₄₁, the control circuit 405 determines that the current I₄ is less than the predetermined current I_{ref4} through the detection circuit 403 and determines that the time of the control signal PW₄₁ maintaining a high voltage is longer than or equal to the predetermined period of time tp₃. In such cases, the control circuit 405 provides the control signal PW₄₂ with high voltage and the control signals PW₄₁ and PW₄₃ with low voltage, which establishes the current-transmission path between the battery device 412 and the energy-storage circuit 404. Based on the operation described above, the energy-harvesting system 400 provides the current I₄₃, which is provided by the battery device 412, to the energy-storage circuit 404, which increases the current provided to the energy-storage circuit 404 and reduces the time required for the current I₄ to be increased to the predetermined current I_{ref4}. At time t₄₂, the control circuit 405 determines that the current I₄ is greater than or equal to the predetermined current I_{ref4} through the detection circuit 403. Accordingly, the control circuit 405 provides the control signal PW₄₃ with high voltage and the control signals PW₄₁ and PW₄₂ with low voltage, which disconnects the current-transmission paths between the energy-harvesting circuit 411, the battery device 412, and the energy-storage circuit 404 and establishes the current-transmission path between the energy-storage circuit 404 and the load device 402. In such cases, the energy-storage circuit 404 may provide the current I₄₂ to the load device 402.

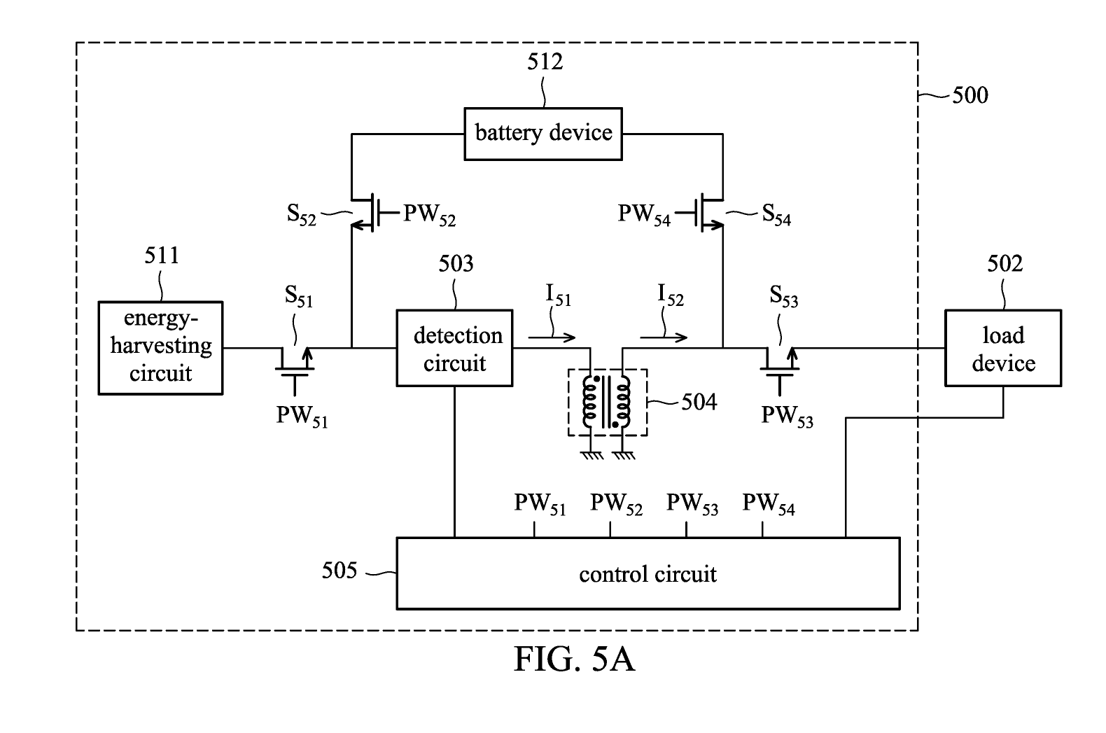

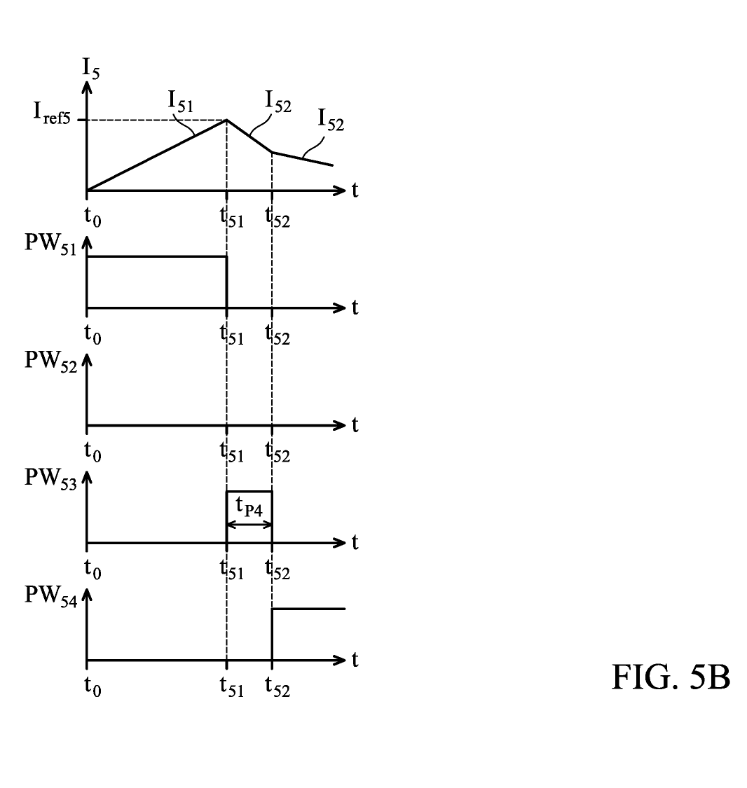

In some embodiments, in addition to charging the energy-storage circuit, the battery device may also receive power from the energy-storage circuit, as shown in FIG. 5A. FIG. 5A is a schematic view of an energy-harvesting system 500 according to an exemplary embodiment. The energy-harvesting system 500 includes an energy-harvesting circuit 511, a battery device 512, a detection circuit 503, an energy-storage circuit 504, a control circuit 505, and a switching circuit. In this embodiment, the switching circuit is formed by the transistors S₅₁, S₅₂, S₅₃ and S₅₄, and the transistors S₅₁, S₅₂, S₅₃ and S₅₄ receive control signals PW₅₁, PW₅₂, PW₅₃, and PW₅₄ provided by the control circuit 505, respectively.

In one embodiment, the energy-harvesting system 500 performs the MPPT on the energy-harvesting circuit 511. The control circuit 505 determines that the current corresponding to the maximum power point of the energy-harvesting circuit 511 is greater than a current threshold and sets the current I_{ref5} based on the current, wherein the current is provided by the energy-harvesting circuit 511. In this embodiment, the energy-harvesting circuit 511 can make the energy-storage circuit 504 store the current which is sufficient to be provided to the load device 502 and the battery device 512.

One embodiment of the energy-harvesting system 500 is illustrated in FIG. 5B. At time t₀, the energy-harvesting circuit 511 is already turned on and the control circuit 505 provides the control signal PW₅₁ with high voltage and the control signals PW₅₂, PW₅₃, and PW₅₄ with low voltage, which establishes the current-transmission path between the energy-harvesting circuit 511 and the energy-storage circuit 504. In such cases, the energy-storage circuit 504 may receive and store the current I₅₁ provided by the energy-harvesting circuit 511 to make the current I₅ stored by the energy-storage circuit 504 gradually increase. At time t51, the control circuit 505 determines that the current I₅ is greater than or equal to the predetermined current I_{ref5} through the detection circuit 503. Accordingly, the control circuit 505 provides the control signal PW₅₃ with high voltage and the control signals PW₅₁, PW₅₂, and PW₅₄ with low voltage, which disconnects the current-transmission paths between the energy-harvesting circuit 511, the battery device 512, and the energy-storage circuit 504 and establishes the current-transmission path between the energy-storage circuit 504 and the load device 502. In such cases, the energy-storage circuit 504 may provide the current I₅₂ to the load device 502.

At time t52 (wherein the control signal PW₅₃ performs high voltage over the predetermined period of time tp₄), the control circuit 505 determines that the load device 502 already receives sufficient electricity (e.g. the determination is based on the setting of the current I_{ref5}). Accordingly, the control circuit 505 provides the control signal PW₅₄ with high voltage and the control signals PW₅₁, PW₅₂, and PW₅₃ with low voltage, which disconnects the current-transmission paths between the energy-harvesting circuit 511, the load device 502, and the energy-storage circuit 504 and establishes the current-transmission path between the energy-storage circuit 504 and the battery device 512. In such cases, the energy-storage circuit 504 may provide the current I₅₂ to the battery device 512.

In one embodiment, the battery device 512 and the energy-harvesting circuit 511 of the energy-harvesting system 500 may individually provide the current to the energy-storage circuit 504. For example, the control circuit 505 may provide the control signal PW₅₁ with high voltage and the control signals PW₅₂, PW₅₃, and PW₅₄ with low voltage, which makes the energy-storage circuit 504 receive and store the current provided by the energy-harvesting circuit 511. Furthermore, the control circuit 505 may provide the control signal PW₅₂ with high voltage and the control signals PW₅₁, PW₅₃, and PW₅₄ with low voltage, which makes the energy-storage circuit 504 receive and store the current provided by the battery device 512. Therefore, the control circuit 505 of the energy-harvesting system 500 can make the battery device 512 provide power to the energy-storage circuit 504, or make the battery device 512 receive power from the energy-storage circuit 504.

In some embodiments, the control circuit 505 includes the voltage-detection circuit or current-detection circuit.

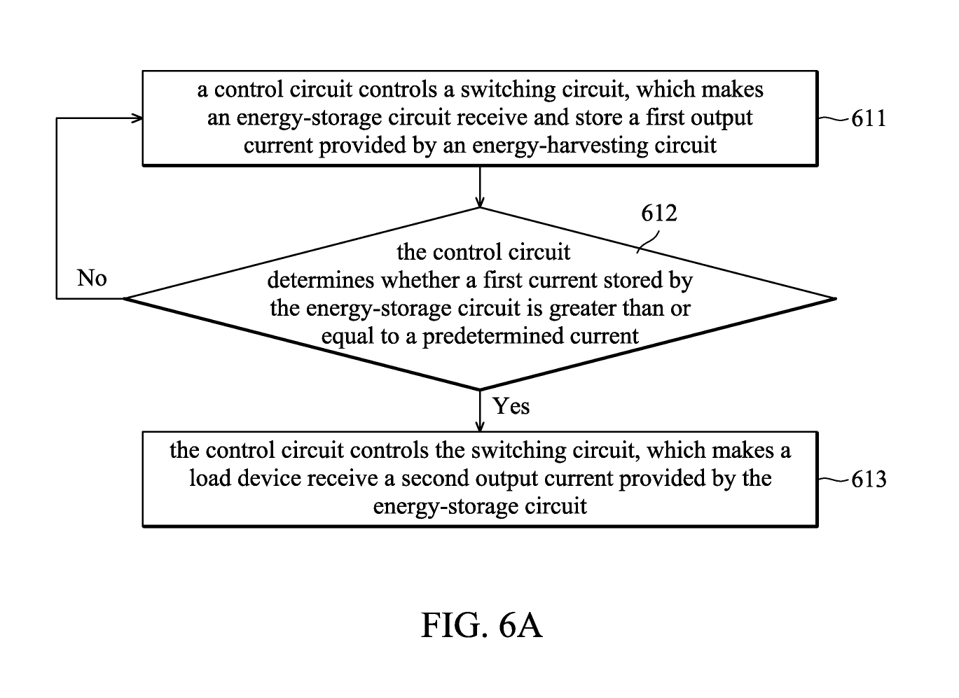

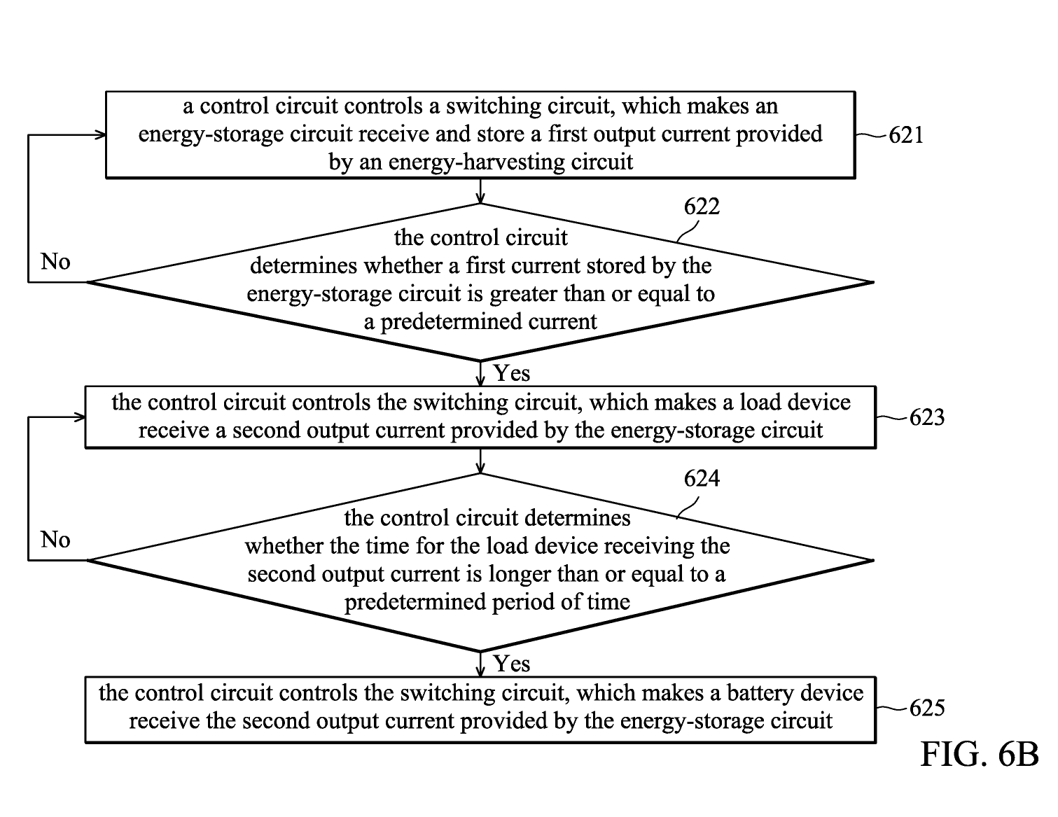

FIG. 6A is a flow diagram of the control method of an energy-harvesting system according to an exemplary embodiment, and the control method in FIG. 6A may correspond to the contents shown in FIG. 2A-2C. The flow begins in step 611. In step 611, the control method utilizes a control circuit to control a switching circuit, which makes an energy-storage circuit receive and store a first output current provided by an energy-harvesting circuit, and the flow goes to step 612. In step 612, the control method utilizes the control circuit to determine whether a first current stored by the energy-storage circuit is greater than or equal to a predetermined current. If the first current is less than the predetermined current, then the flow goes to step 611. If the first current is greater than or equal to the predetermined current, then the flow goes to step 613. In step 613, the control method utilizes the control circuit to control the switching circuit, which makes a load device receive a second output current provided by the energy-storage circuit.

FIG. 6B is a flow diagram of the control method of an energy-harvesting system according to an exemplary embodiment, and the control method in FIG. 6B may correspond to the contents shown in FIG. 5A-5B. The flow begins in step 621. In step 621, the control method utilizes a control circuit to control a switching circuit, which makes an energy-storage circuit receive and store a first output current provided by an energy-harvesting circuit, and the flow goes to step 622. In step 622, the control method utilizes the control circuit to determine whether a first current stored by the energy-storage circuit is greater than or equal to a predetermined current. If the first current is less than the predetermined current, then the flow goes to step 621. If the first current is greater than or equal to the predetermined current, then the flow goes to step 623. In step 623, the control method utilizes the control circuit to control the switching circuit, which makes a load device receive a second output current provided by the energy-storage circuit. The flow goes to step 624. In step 624, the control method utilizes the control circuit to determine whether the time for the load device receiving the second output current is longer than or equal to a predetermined period of time. If the time is longer than or equal to the predetermined period of time, then the flow goes to step 625. Otherwise, the flow goes to step 623. In step 625, the control method utilizes the control circuit to control the switching circuit, which makes a battery device receive the second output current provided by the energy-storage circuit.

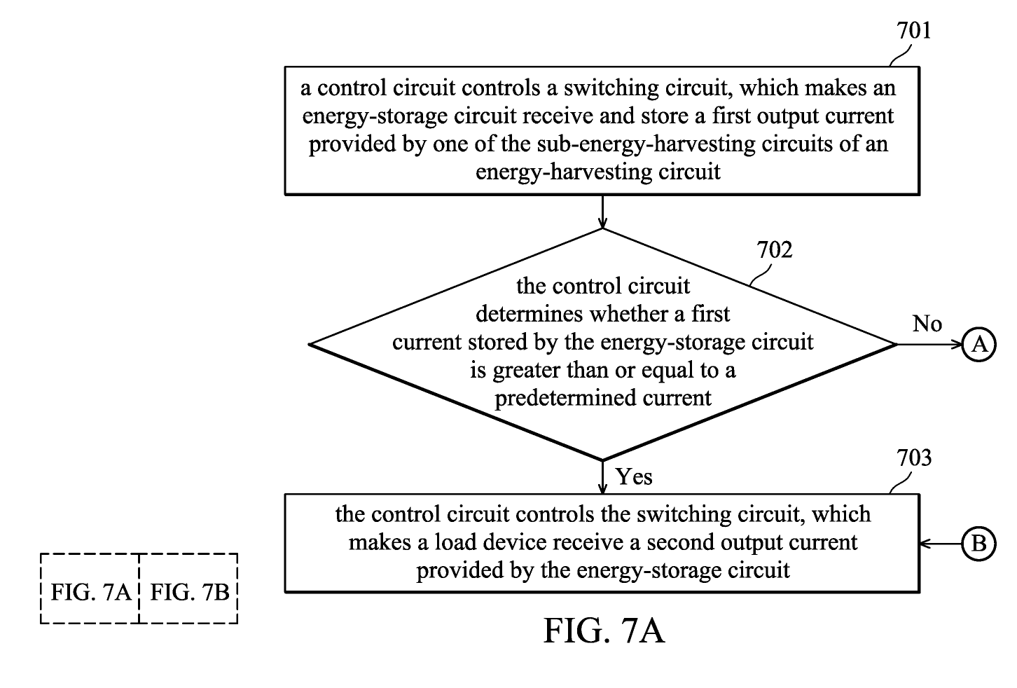

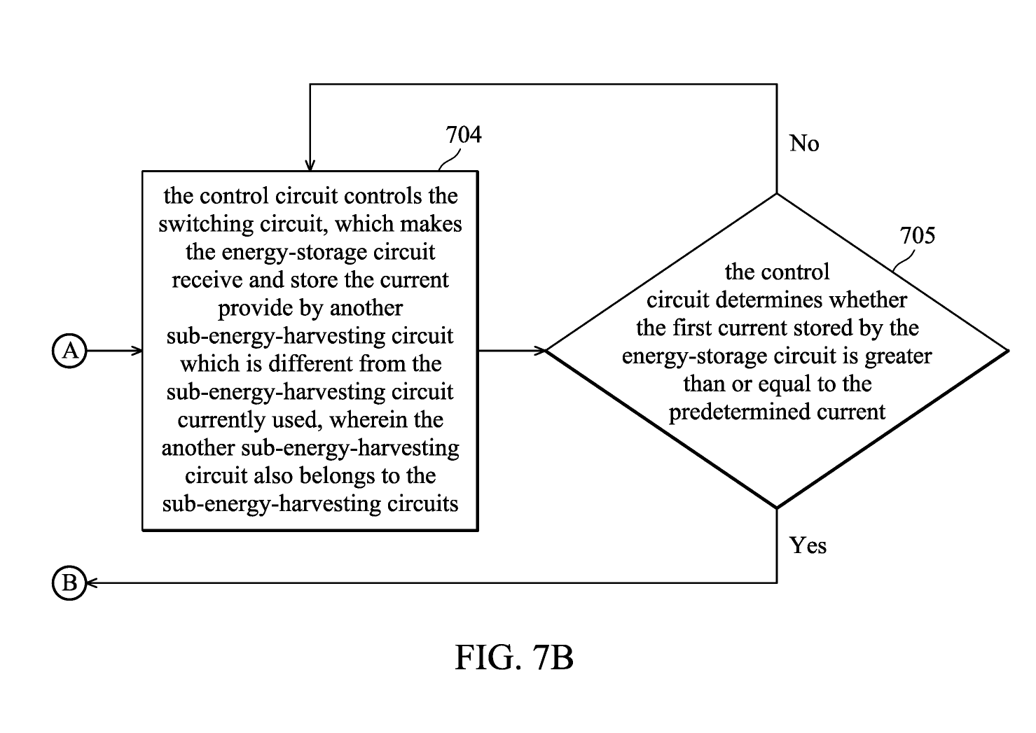

FIG. 7A-7B show a flow diagram of the control method of an energy-harvesting system according to an exemplary embodiment, and the control method in FIG. 7A-7B may correspond to the contents shown in FIG. 3A-3B. The flow begins in step 701. In step 701, the control method utilizes a control circuit to control a switching circuit, which makes an energy-storage circuit receive and store a first output current provided by one of the sub-energy-harvesting circuits of an energy-harvesting circuit, and the flow goes to step 702. In step 702, the control method utilizes the control circuit to determine whether a first current stored by the energy-storage circuit is greater than or equal to a predetermined current. If the first current is less than the predetermined current, then the flow goes to step 704. If the first current is greater than or equal to the predetermined current, then the flow goes to step 703. In step 704, the control method utilizes the control circuit to control the switching circuit, which makes the energy-storage circuit receive and store the current provide by another sub-energy-harvesting circuit which is different from the sub-energy-harvesting circuit currently used, wherein the another sub-energy-harvesting circuit also belongs to the sub-energy-harvesting circuits. The flow goes to step 705. In step 705, the control method utilizes the control circuit to determine whether the first current stored by the energy-storage circuit is greater than or equal to the predetermined current. If the first current is less than the predetermined current, then the flow goes to step 704. If the first current is greater than or equal to the predetermined current, then the flow goes to step 703. In step 703, the control method utilizes the control circuit to control the switching circuit, which makes a load device receive a second output current provided by the energy-storage circuit.

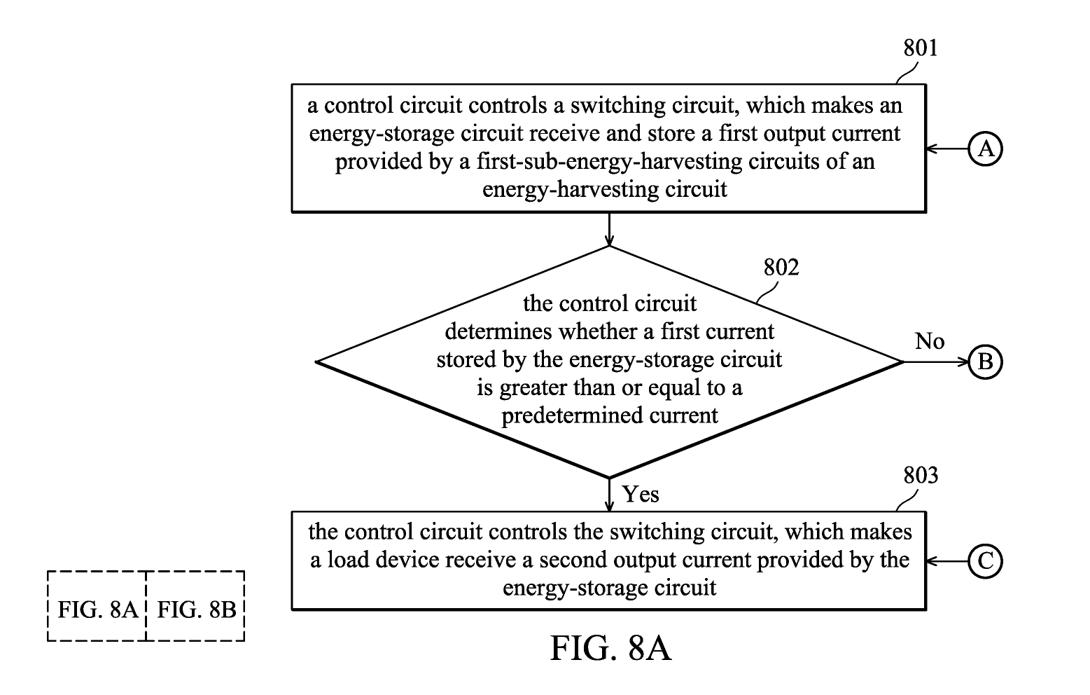

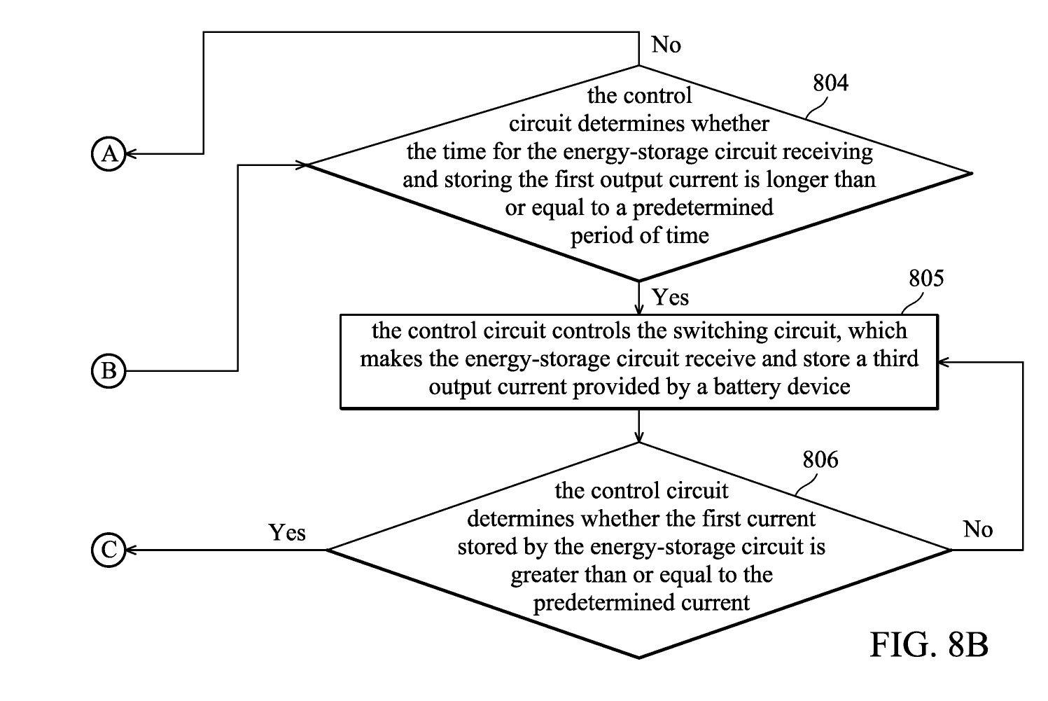

FIG. 8A-8B show a flow diagram of the control method of an energy-harvesting system according to an exemplary embodiment, and the control method in FIG. 8A-8B may correspond to the contents shown in FIG. 4A-4B. The flow begins in step 801. In step 801, the control method utilizes a control circuit to control a switching circuit, which makes an energy-storage circuit receive and store a first output current provided by a first-sub-energy-harvesting circuits of an energy-harvesting circuit, and the flow goes to step 802. In step 802, the control method utilizes the control circuit to determine whether a first current stored by the energy-storage circuit is greater than or equal to a predetermined current. If the first current is less than the predetermined current, then the flow goes to step 804. If the first current is greater than or equal to the predetermined current, then the flow goes to step 803. In step 804, the control method utilizes the control circuit to determine whether the time for the energy-storage circuit receiving and storing the first output current is longer than or equal to a predetermined period of time. If the time is longer than or equal to the predetermined period of time, then the flow goes to step 805. Otherwise, the flow goes to step 801. In step 805, the control method utilizes the control circuit to control the switching circuit, which makes the energy-storage circuit receive and store a third output current provided by a battery device. The flow goes to step 806. In step 806, the control method utilizes the control circuit to determine whether the first current stored by the energy-storage circuit is greater than or equal to the predetermined current. If the first current is less than the predetermined current, then the flow goes to step 805. If the first current is greater than or equal to the predetermined current, then the flow goes to step 803. In step 803, the control method utilizes the control circuit to control the switching circuit, which makes a load device receive a second output current provided by the energy-storage circuit.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An energy-harvesting system, comprising
an energy-harvesting circuit;
an energy-storage circuit;
a detection circuit, coupled to the energy-storage circuit to detect a first current stored by the energy-storage circuit;
a switching circuit, coupled to the energy-harvesting circuit, the energy-storage circuit, and a load device; and
a control circuit, coupled to the detection circuit and the switching circuit;
wherein the control circuit determines that the first current is less than a predetermined current, the control circuit controls the switching circuit to make the energy-storage circuit receive and store a first output current provided by the energy-harvesting circuit; and
the control circuit determines that the first current is greater than or equal to the predetermined current, the control circuit controls the switching circuit to make the load device receive a second output current provided by the energy-storage circuit.

2. The energy-harvesting system as claimed in claim 1, wherein the energy-harvesting circuit comprises a plurality of sub-energy-harvesting circuits, and the sub-energy-harvesting circuits are separately coupled to the switching circuit;
wherein the control circuit controls the switching circuit to make the sub-energy-harvesting circuits alternatively provide the first output current.

3. The energy-harvesting system as claimed in claim 2, wherein the sub-energy-harvesting circuits comprise a first-sub-energy-harvesting circuit and a second-sub-energy-harvesting circuit;
wherein the first-sub-energy-harvesting circuit continuously provides the first output current for a first-predetermined period of time, the control circuit controls the switching circuit to make the second-sub-energy-harvesting circuit provide the first output current if the control circuit determines that the first current is less than the predetermined current; and
the second-sub-energy-harvesting circuit continuously provides the first output current for a second-predetermined period of time, the control circuit controls the switching circuit to make the first-sub-energy-harvesting circuit provide the first output current if the control circuit determines that the first current is less than the predetermined current.

4. The energy-harvesting system as claimed in claim 1, further comprising a battery device coupled to the switching circuit;
wherein the control circuit determines that the first current is less than the predetermined current and determines that the energy-storage circuit receives and stores the first output current for a period of time which is longer than or equal to a third-predetermined period of time, the control circuit controls the switching circuit to make the energy-storage circuit receive and store a third output current provided by the battery device.

5. The energy-harvesting system as claimed in claim 1, which further comprises a battery device coupled to the switching circuit;
wherein the load device continuously receives the second output current for a fourth-predetermined period of time, the control circuit controls the switching circuit to provide the second output current to the battery device.

6. The energy-harvesting system as claimed in claim 1, wherein the energy-storage circuit is a transformer, and the switching circuit comprises a first switch and a second switch;
wherein the first switch is connected to the energy-harvesting circuit, the control circuit, and the detection circuit;
the transformer is connected to the detection circuit and the second switch; and
the second switch is connected to the transformer, the load device, and the control circuit.

7. The energy-harvesting system as claimed in claim 1, wherein the energy-storage circuit is an inductor, and the inductor comprises a first terminal and a second terminal;
wherein the switching circuit comprises:
a first switch, connected to the energy-harvesting circuit, the first terminal, and the control circuit;
a second switch, connected to the second terminal, a ground terminal of the energy-harvesting circuit, and the control circuit;
a third switch, connected to the first terminal, a ground terminal of the load device, and the control circuit; and
a fourth switch, connected to the second terminal, the load device, and the control circuit.

8. A control method of an energy-harvesting system, comprising:
controlling, with a control circuit, a switching circuit to make an energy-storage circuit receive and store a first output current provided by an energy-harvesting circuit;
wherein the control circuit determines that a first current stored by the energy-storage circuit is less than a predetermined current, the control circuit controls the switching circuit to make the energy-storage circuit receive and store the first output current; and
the control circuit determines that the first current is greater than or equal to the predetermined current, the control circuit controls the switching circuit to make a load device receive a second output current provided by the energy-storage circuit.

9. The control method as claimed in claim 8, further comprising:
controlling, by the control circuit, the switching circuit to make a plurality of sub-energy-harvesting circuits of the energy-harvesting circuit alternatively provide the first output current.

10. The control method as claimed in claim 9, wherein:
a first-sub-energy-harvesting circuit of the sub-energy-harvesting circuits continuously provides the first output current for a first-predetermined period of time, the control circuit controls the switching circuit to make a second-sub-energy-harvesting circuit of the sub-energy-harvesting circuits provide the first output current if the control circuit determines that the first current is less than the predetermined current; and
the second-sub-energy-harvesting circuit continuously provides the first output current for a second-predetermined period of time, the control circuit controls the switching circuit to make the first-sub-energy-harvesting circuit provide the first output current if the control circuit determines that the first current is less than the predetermined current.

11. The control method as claimed in claim 8, further comprising:
wherein the control circuit determines that the first current is less than the predetermined current and determines that the energy-storage circuit receives and stores the first output current for a period of time which is longer than or equal to a third-predetermined period of time, the control circuit controls the switching circuit to make the energy-storage circuit receive and store a third output current provided by a battery device.

12. The control method as claimed in claim 8, further comprising:
wherein the load device continuously receives the second output current for a fourth-predetermined period of time, the control circuit controls the switching circuit to provide the second output current to a battery device.
